(19) United States
(12) Patent Application Publication
(10) Pub. No.: US 2026/0219390 A1
(43) Pub. Date: Jul. 30, 2026

(54) OPTOELECTRONIC SENSOR

(71) Applicant: TMSS FRANCE, Courbevoie (FR)

(72) Inventor: Jacques BERNARD, L'ISLE D'ESPAGNAC (FR)

(73) Assignee: TMSS FRANCE, Courbevoie (FR)

(21) Appl. No.: 19/148,737

(22) PCT Filed: Jan. 31, 2024
(86) PCT No.: PCT/FR2024/050127

§ 371 Date: Jul. 17, 2025

(30) Foreign Application Priority Data
Jan. 31, 2023 (FR) FR2300856

(51) Int. Cl. G01S 17/04; G01S 7/481

(52) U.S. Cl. CPC G01S 17/04; G01S 7/4816

(57) ABSTRACT

An optoelectronic sensor configured to detect the presence of an object in a predetermined region via reflection of at least one light beam, the sensor includes a subtracting stage configured to generate an output voltage by subtracting a second voltage generated using a second photodiode from a first voltage generated using a first photodiode following emission of at least one beam; a summing stage configured to generate an output voltage by adding the first voltage to the second voltage; the optoelectronic sensor is configured so that a difference between a first luminous flux received by the first photodiode and a second flux received by the second photodiode is positive when a beam is reflected when the object is in the predetermined region; and to detect the object based on the output voltages of the subtracting stage and summing stage.

### TECHNICAL FIELD

The present disclosure relates to the field of optoelectronic sensors configured to detect the presence of an object in a predetermined detection area through reflection of a light beam from this object.

### BACKGROUND

Optoelectronic sensors are nowadays used to detect the presence of an object in a predetermined detection area.

These sensors emit a light beam into the predetermined detection area and monitor the electrical output signal of a photodiode in response to the emission of the light beam. In this case, the electrical output signal of the photodiode is proportional to the luminous flux received by the photodiode. This electrical output signal is different when the object is or is not in the predetermined detection area, since the object will reflect the light beam emitted by the sensor. Therefore, monitoring the electrical output signal of the photodiode may make it possible to detect the presence or absence of the object in the predetermined detection area.

However, the electrical output signal from the photodiode is generally very weak, and so this output signal is relatively sensitive to noise. In particular, the luminous flux surrounding the sensor and the intrinsic reflective character of the object to be detected, which depends in part on its color, may sometimes alter the operation of the sensor.

The present disclosure aims to improve this situation.

### SUMMARY

In this respect, what is proposed is an optoelectronic sensor configured to detect a presence of an object in a predetermined detection area through reflection of at least one light beam from said object, the optoelectronic sensor comprising:
a light source adapted to emit the at least one light beam with a predetermined orientation;
a first photodiode configured to generate a first electric current as a function of
a first luminous flux on the first photodiode;
a second photodiode configured to generate a second electric current as a function of a second luminous flux on the second photodiode;
a converter stage configured to convert the first and second electric currents
a subtractor stage configured to generate an output voltage by subtracting the second voltage from the first voltage;
a summing stage configured to generate an output voltage by adding the first voltage to the second voltage;
   wherein the optoelectronic sensor is configured:
such that a difference between the first luminous flux received by the first photodiode and the second luminous flux received by the second photodiode is positive when a light beam is reflected by an object positioned in the predetermined detection area; and
to detect an object based on the output voltages of the subtractor stage and the summing stage.

Optionally, the optoelectronic sensor furthermore comprises a signal amplifier stage capable of amplifying the first and second electric currents or capable of amplifying the first and second voltages.

Optionally, the converter stage is also an amplifier stage and comprises a first transimpedance amplifier capable of amplifying and converting the first electric current into a first voltage and a second transimpedance amplifier capable of amplifying and converting the second electric current into a second voltage.

Optionally, the optoelectronic sensor furthermore comprises an ambient-light compensation stage configured to reduce the portion of current induced by ambient light in the current generated by the photodiodes.

Optionally, the subtractor stage and the summing stage also comprise an amplifier that amplifies their respective output voltage.

Optionally, the optoelectronic sensor furthermore comprises a filtering stage configured to filter the first and second voltages.

Optionally, the optoelectronic sensor furthermore comprises:
an emission lens arranged facing the light source so that the light beam emitted by the light source passes through the emission lens; and
a reception lens arranged facing the first and second photodiodes so that the fluxes received by the first and second photodiodes pass through the reception lens.

In a first option, the optoelectronic sensor is configured to detect an object in the predetermined detection area when:
a) the output voltage of the subtractor stage is positive when a light beam is emitted, and
b) the output voltage of the summing stage is greater than a predetermined first voltage threshold when the light beam is emitted.

In the first option, the first voltage threshold is a hysteresis threshold having a lower bound and an upper bound, the difference between the lower bound and the upper bound being greater than a voltage amplitude predetermined as corresponding to a voltage amplitude due to noise on the output voltage of the summing stage.

In a second option, the optoelectronic sensor furthermore comprises a controlled inverter stage and an integrator stage, the controlled inverter stage comprising:
a first controlled inverter connected to the subtractor stage and configured to invert the output voltage of the subtractor stage during the time intervals between the emission of two consecutive light beams of the time sequence of light beams;
a second controlled inverter connected to the summing stage and configured to invert the output voltage of the summing stage during the time intervals between the emission of two consecutive light beams of the time sequence of light beams;
   the integrator stage comprising:
a first integrator connected to the first controlled inverter and configured to integrate the output voltage of the subtractor stage, partially inverted by the first controlled inverter stage, so as to obtain a subtractor detection signal; and
a second integrator connected to the second controlled inverter and configured to integrate the output voltage of the summing stage, partially inverted by the second controlled inverter stage, so as to obtain a summer detection signal; and
   wherein the optoelectronic sensor is configured to detect an object in the predetermined detection area when:
a) the detection signal of the subtractor is positive, and
b) the detection signal of the summer is greater than a determined second voltage threshold.

The application also relates to a method for detecting an object in a predetermined detection area through reflection of at least one light beam from the object using any one of the examples of optoelectronic sensors presented in the present disclosure, the method comprising:

emitting the at least one light beam in a predetermined time interval using the light source; obtaining the output voltage of the subtractor stage during the predetermined time interval, the output voltage of the subtractor stage being composed of amplitudes generated by the at least one light beam;
obtaining the output voltage of the summing stage during the predetermined time interval, the output voltage of the summing stage being composed of amplitudes generated by the at least one light beam of the sequence of light beams; and
detecting an object in the predetermined detection area based on the obtained output voltages of the subtractor stage and of the summing stage.

Optionally, the method is implemented using an optoelectronic sensor according to the second option, and the method comprises:

emitting a time sequence of light beams in a predetermined time interval using the light source;
obtaining the output voltage of the subtractor stage during the predetermined time interval, the output voltage of the subtractor stage being composed of amplitudes generated by the light beams of the sequence of light beams;
processing the output voltage of the subtractor stage by inverting the output voltage of the subtractor stage during the time intervals between the emission of two consecutive light beams of the time sequence of light beams and then integrating the partially rectified voltage so as to obtain a subtractor detection signal, from the first controlled inverter and the first integrator;
obtaining the output voltage of the summing stage during the predetermined time interval, the output voltage of the summing stage being composed of amplitudes generated by the light beams of the sequence of light beams;
processing the output voltage of the summing stage by inverting the output voltage of the summing stage during the time intervals between the emission of two consecutive light beams of the time sequence of light beams and then integrating the partially rectified voltage so as to obtain a detection signal of the summer, from the second controlled inverter and the second integrator; and
detecting the object in the predetermined detection area when:
a) the detection signal of the subtractor is positive; and
b) the detection signal of the summer is greater than a determined second voltage threshold.

The examples of an optoelectronic sensor and detection method presented in the present disclosure thus make it possible to guarantee detection stability (object detected or not detected) by ensuring a sufficient signal-to-noise ratio, be this with regard to electronic noise introduced by the various electronic components of the optoelectronic sensor or noise introduced by ambient light in the generation of current by the photodiodes. In this case, the fact that the optoelectronic sensor according to the present disclosure uses the output voltage of a summing stage that adds the voltages resulting from the currents generated by the first and second photodiodes in the detection of an object in the predetermined detection area makes it possible to guarantee detection stability by ensuring a sufficient signal-to-noise ratio that makes it possible to avoid switching from one state to another (detected or not detected) due to noise. Moreover, in the second examples of an optoelectronic sensor based on the emission of a time sequence of light beams to detect an object in the predetermined area, the influence of noise on detection stability is reduced further. Specifically, noise on the voltages is filtered by the combination of the controlled inverter stage and the integrator stage, and the output voltages that are compared to detect or not detect an object (the detection signals) have an increased amplitude level compared to the first examples, thereby further increasing the signal-to-noise ratio, thus improving detection stability.

### BRIEF DESCRIPTION OF THE DRAWINGS

Other features, details and advantages will become apparent on reading the detailed description below and on analyzing the appended drawings, in which:

FIG. 1 schematically shows one example of an optoelectronic sensor configured to detect the presence of an object in a predetermined detection area through reflection of a light beam from said object.

FIG. 2 shows a basic diagram of the detection of an object through triangulation using one example of an optoelectronic sensor.

FIG. 3 schematically shows another example of an optoelectronic sensor configured to detect the presence of an object in a predetermined detection area through reflection of a sequence of light beams from said object.

FIG. 4 shows a flowchart of one example of a method for detecting an object in a predetermined detection area through reflection of at least one light beam from the object using an optoelectronic sensor according to the present disclosure.

FIG. 5a shows the time evolution of the voltage signals measured at the output of various electronic stages of an optoelectronic sensor in response to the emission of a time sequence of light beams when an object reflecting the light beams is positioned in a predetermined detection area.

FIG. 5b shows the time evolution of the voltage signals measured at the output of various electronic stages of the optoelectronic sensor in response to the emission of the same time sequence of light beams as that used in FIG. 5a when the object reflecting the light beams is positioned beyond the predetermined detection area.

### DETAILED DESCRIPTION OF

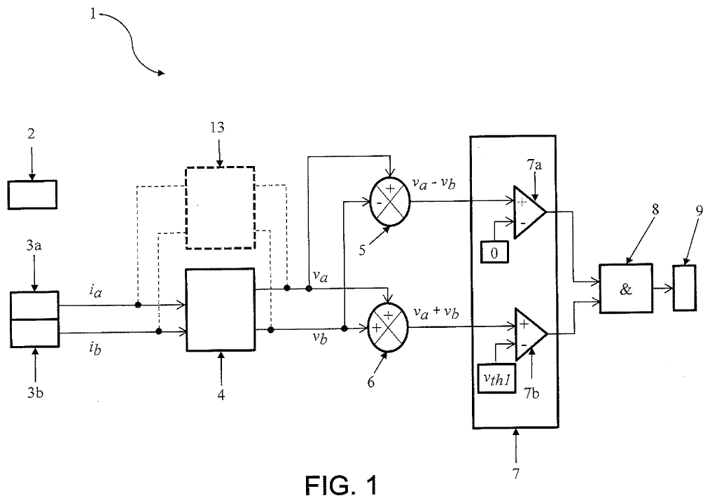

A description will now be given, with reference to FIGS. 1 to 3, of one example of an optoelectronic sensor 1 configured to detect the presence of an object 10 in a predetermined detection area through reflection of at least one light beam from said object. The optoelectronic sensor 1 may correspond to a background suppressing sensor that detects the presence of an object through triangulation.

The optoelectronic sensor 1 comprises a light source 2 designed to emit the at least one light beam with a predetermined orientation. In some examples detailed below, the light source 2 is designed to emit a time sequence of light beams. The light source 2 may for example correspond to a light-emitting diode. It is the reflection of at least one light beam from the object 10 that will make it possible to determine its presence, in particular through triangulation, as explained below. The predetermined detection area Zd is therefore defined as a function of the predetermined orientation of the light beam when using the sensor 1. A light beam may for example correspond to a red light beam or an infrared light beam.

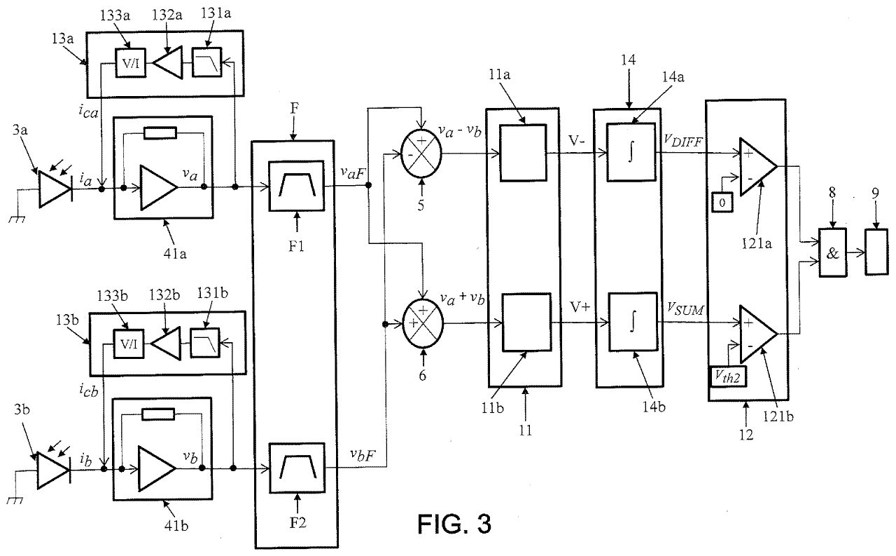

The optoelectronic sensor 1 comprises a first photodiode 3a and a second photodiode 3b. The first photodiode 3a is configured to generate a first electric current iₐ as a function of a first luminous flux received by the first photodiode 3a. In the same way, the second photodiode 3b is configured to generate a second electric current i_{b} as a function of a second luminous flux received by the second photodiode 3b. Each of the photodiodes is connected to a ground of the optoelectronic sensor, as shown in FIG. 3.

The optoelectronic sensor 1 comprises a converter stage 4 configured to convert the first and second electric currents, generated by the first and second photodiode 3a and 3b, respectively, into first and second voltages vₐ and v_{b}. The converter stage 4 thus converts the first electric current iₐ, generated by the first photodiode 3a from the luminous flux that it receives, into a first voltage vₐ. It also converts the second electric current i_{b}, generated by the second photodiode 3b from the luminous flux that it receives, into a second voltage v_{b}.

The optoelectronic sensor 1 comprises a subtractor stage 5. The subtractor stage 5 is configured to generate an output voltage by subtracting the second voltage v_{b} from the first voltage vₐ. The subtractor stage 5 may also comprise an amplifier for amplifying the output voltage of the subtractor stage. In some examples, the subtractor stage 5 may comprise an operational amplifier.

The optoelectronic sensor 1 comprises a summing stage 6. The summing stage 6 is configured to generate an output voltage by adding the first voltage vₐ to the second voltage v_{b}. The summing stage 6 may also comprise an amplifier for amplifying the output voltage of the summing stage. In some examples, the summing stage 6 may comprise an operational amplifier.

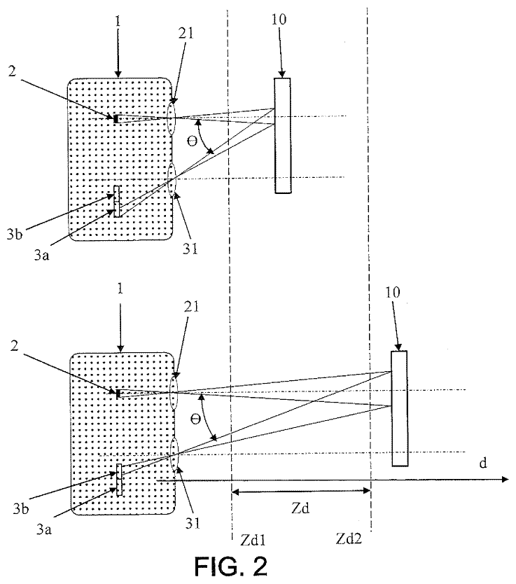

The optoelectronic sensor 1 is configured such that a difference between the first luminous flux received by the first photodiode and the second luminous flux received by the second photodiode is positive when the light beam is reflected by an object positioned in the predetermined detection area. In this case, a position of the photodiodes 3a and 3b with respect to one another is determined such that a difference between the first luminous flux received by the first photodiode and the second luminous flux received by the second photodiode is positive when the light beam is reflected by an object positioned in the predetermined detection area. The photodiodes are arranged side by side, contiguously, as shown in FIG. 2. The arrangement of the photodiodes 3 and the predetermined detection area depend directly on the application in which the optoelectronic sensor 1 will be used. The optoelectronic sensor 1 that is presented may thus be used to detect an object passing through a given position opposite the sensor on a conveying path. This is akin for example to a suitcase traveling on an airport conveyor belt or a part moving on a production line.

In particular, and as illustrated in FIG. 2, it is possible to detect the presence of an object in a detection area through triangulation using an electronic sensor 1. FIG. 2 shows a basic diagram of the detection of an object through triangulation using one example of an optoelectronic sensor 1 according to the present disclosure. This is a side view, perpendicular to the optical axis of the light beam emitted by the light source 2, of one example of a sensor 1 when the object 10 is in the predetermined detection area Zd (top image), and when it is outside same (bottom image). The axis d represents the distance between the sensor 1 and the object 10 to be detected, and the predetermined detection area Zd extends between two extrema Zd1 and Zd2. The light source 2 of the sensor 10 thus emits a light beam that passes first through an emission lens 21, the beam then being reflected by the object 10, and then directed toward the photodiodes 3a and 3b by a reception lens 31, an angle θ being formed between the light beam emitted by the light source 2 and the light beam reflected by the object 10. It will be understood, as illustrated by FIG. 2, that the angle θ varies as a function of the distance of the object 10 from the sensor 1, as does the luminous flux received by the photodiodes 3, which depends on this angle. FIG. 2 schematically shows that, when the object 10 is located in the predetermined detection area Zd, only the first photodiode 3a receives the reflected light beam, whereas, when the object 10 is outside the predetermined detection area Zd, only the second photodiode 3b receives the reflected luminous flux. The object 10 is therefore detected when the first photodiode 3a receives the reflected luminous flux. However, this is a schematic depiction used to give an understanding of the detection principle used. In reality, the reflected luminous flux is received with greater or lesser intensity by the two photodiodes 3 as a function of the distance of the object 10 from the sensor 1. It is therefore by then comparing these luminous fluxes, using the currents generated by the photodiodes, that the optoelectronic sensor 1 is capable of detecting whether or not the object 10 is in the predetermined detection area Zd. In particular, the extremum Zd2 is determined as corresponding to an equivalent received luminous flux between the two photodiodes 3, such that, when the object 10 approaches the sensor 1 along the optical axis from this extremum Zd2, the first photodiode 3a receives more reflected luminous flux than the second photodiode 3b, thus signifying the presence of the object 10 in the predetermined detection area Zd. Conversely, when the object 10 moves away from the sensor 1 along the optical axis from this extremum Zd2, the first photodiode 3a receives less reflected luminous flux than the second photodiode 3b, signifying the absence of the object 10 in the predetermined detection area Zd.

In the present disclosure, the optoelectronic sensor 1 is configured to detect an object in the predetermined detection area Zd based on the output voltages of the subtractor stage 5 and the summing stage 6.

In particular, in some first examples, the optoelectronic sensor 1 is configured to detect an object in the predetermined detection area Zd when:
a) the output voltage of the subtractor stage 5 is positive when a light beam is emitted,
b) the output voltage of the summing stage 6 is greater than a predetermined first voltage threshold vₜₕ₁ when the light beam is emitted.
These first examples are shown in FIG. 1 and may make it possible to detect an object 10 in the predetermined detection area through the emission of a single light beam emitted by the light source 2.

Thus, in these first examples, the optoelectronic sensor 1 may comprise a comparator stage 7 comprising a first comparator 7a configured to compare the output voltage of the subtractor stage 5 with a zero voltage, and a second comparator 7b configured to compare the output voltage of the summing stage 6 with the predetermined first voltage threshold vₜₕ₁. The optoelectronic sensor 1 may furthermore comprise a logic gate 8 that applies an AND function, receiving the outputs from the first comparator 7a and the second comparator 7b at input, and that transmits a logic signal to a detection unit 9 that triggers detection of an object 10 in the predetermined detection area Zd when the logic signal from the AND gate 8 that it receives is at 1.

A positive output voltage of the subtractor stage 5 (condition a) corresponds to the fact that the first generated current iₐ is greater than the second generated current i_{b}, this signifying, in theory, that the luminous flux received by the first photodiode 3a is greater than the luminous flux received by the second photodiode 3b. Insofar as the arrangement of the photodiodes 3 is determined such that a luminous flux received by the first photodiode 3a is greater than a luminous flux received by the second photodiode 3b when the object 10 is in the predetermined detection area Zd, an object 10 should simply be detected in the predetermined detection area when this condition is met. This is the detection principle explained above. This detection condition makes it possible to make the detection distance of an object 10 in a predetermined detection area Zd by the optoelectronic sensor 1 independent of the reflective character of the object 10 under consideration. Indeed, the detection principle used by the presented optoelectronic sensor 1 is based on a difference in luminous fluxes received by the photodiodes, such that, even when the luminous flux is reflected by an object 10 whose reflective character is weak, for example when the object is black, there will still be a difference in received luminous flux between each of the photodiodes 3 as a function of the position of the object 10, even if the luminous fluxes received independently by each of the photodiodes are attenuated. To this extent, the presented optoelectronic sensor 1 makes it possible to detect an object 10 at a detection distance independent of the intrinsic reflective character of the object 10 under consideration in this detection.

However, the inventors noted that electronic noise introduced by the photodiodes 3 and the electronic stages of the optoelectronic sensor were able to induce a negative output voltage of the subtractor stage while the object to be detected was still in the predetermined detection area, after first detection of the object, thereby making the detection character of the optoelectronic sensor potentially unstable. In other words, the inventors noted that the optoelectronic sensor was able to detect the presence of an object in the detection area Zd at a time t, and then detect its absence at the time t+1 due to noise on the output voltage of the subtractor stage 5, making it relatively complicated to interpret the object detection information.

Therefore, in the first examples, the optoelectronic sensor 1 is also configured to satisfy condition b) before detecting an object 10 in the predetermined detection area. As explained above, the optoelectronic sensor 1 according to the present disclosure comprises a summing stage 6 that adds the first and second voltages vₐ and v_{b}, and the optoelectronic sensor is furthermore configured to compare this sum with the predetermined first voltage threshold vₜₕ₁. Comparing whether the output voltage (vₐ+v_{b}) from the summing stage 6 is greater than the predetermined first voltage threshold vₜₕ₁ in order to detect an object in the predetermined detection area Zd makes it possible to guarantee good detection stability by ensuring a sufficient signal-to-noise ratio.

Moreover, verifying that the sum of the first and second output voltages vₐ and v_{b} is greater than a threshold (vₜₕ₁) also makes it possible to discriminate a situation in which the object is positioned at a distance corresponding to the extremum Zd2 of the predetermined area Zd for which the currents generated by the photodiodes are equal; and therefore the output voltage of the subtractor stage is zero; from a situation in which there is no object facing the sensor at all, the light beam therefore being not reflected and the currents generated by the photodiodes being zero, also inducing a zero output voltage of the subtractor stage.

To this extent, the summing stage 6 makes it possible to stabilize the detection of an object in the predetermined detection area Zd by ensuring a signal-to-noise ratio sufficient to make a detection decision, and also makes it possible to discriminate a situation in which the object is positioned at a distance from the sensor corresponding to the extremum Zd2 from a situation in which no object reflects the light beam.

In the first examples, the predetermined first voltage threshold vₜₕ₁ may be determined based on an average output voltage of the summing stage 5 when there is no object in the detection area Zd and/or on an average output voltage of the summing stage 5 when there is an object beyond the detection area Zd reflecting the light beam. In particular, the predetermined first voltage threshold vₜₕ₁ may for example be determined as being greater than a determined percentage of the average output voltage of the summing stage 5 when there is no object in the detection area and/or than a percentage of the average output voltage of the summing stage 5 when there is an object beyond the detection area Zd reflecting the light beam. In these first examples, the predetermined first voltage threshold vₜₕ₁ may be determined so as to ensure a signal-to-noise ratio greater than a determined ratio. These alternatives make it possible to guarantee detection stability for an object in the predetermined detection area Zd by ensuring a sufficient signal-to-noise ratio on the output voltage of the summing stage 6 so as to comply with detection condition b) presented above.

In some examples, the predetermined first voltage threshold vₜₕ₁ is a hysteresis threshold having an upper bound and a lower bound. In these examples, the optoelectronic sensor is configured to detect the object in the predetermined detection area Zd when the output voltage of the subtractor stage is positive and when the output voltage of the summing stage 6 is greater than the upper bound of the predetermined first voltage threshold vₜₕ₁ when the light beam is emitted. In these examples, the optoelectronic sensor is also configured to interrupt the detection of the object when the output voltage of the summing stage 6 is lower than the lower bound of the hysteresis threshold of the predetermined first voltage threshold vₜₕ₁ when the light beam is emitted. The lower bound of the hysteresis threshold may for example be determined based on a maximum noise voltage generated by the electronic components of the sensor on the output voltage of the summing stage 6. In particular, the lower bound of the hysteresis threshold may be determined such that a difference between the lower bound and the upper bound is greater than a voltage amplitude predetermined as corresponding to a voltage amplitude due to noise on the output voltage of the summing stage. This voltage amplitude due to noise on the output voltage of the summing stage may be predetermined based on tests carried out on the optoelectronic sensor.

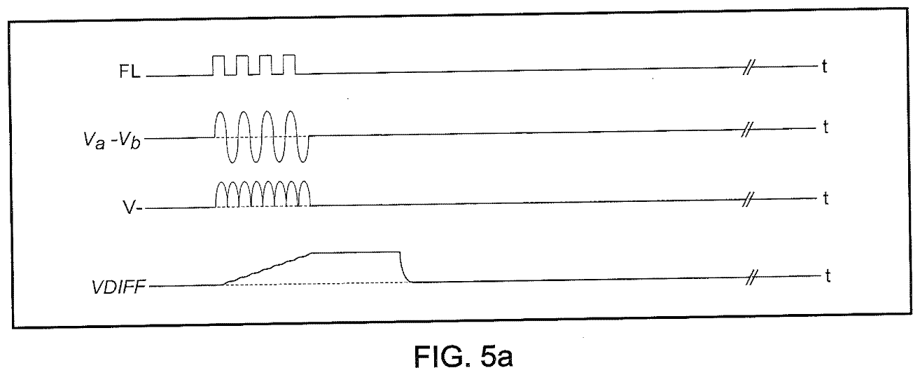

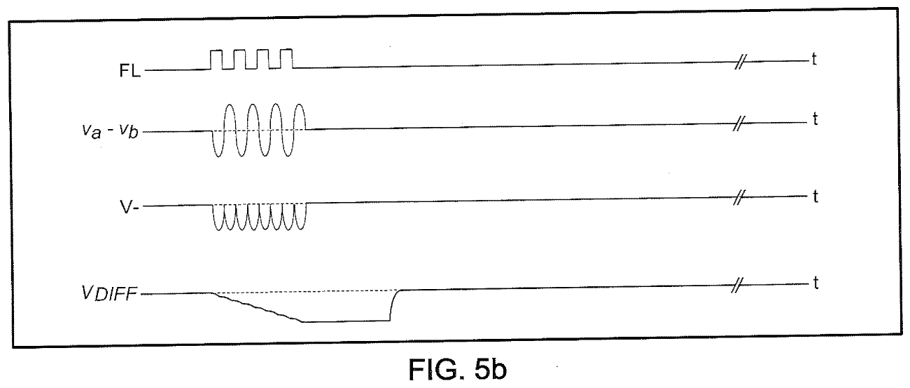

In some second examples, the optoelectronic sensor 1 considers a time sequence of light beams emitted by the light source 2 to detect whether or not an object is present in the predetermined detection area. The sequence of light beams designates the emission, by the light source 2, of a plurality of light beams at a determined frequency. The time sequence of light beams is shown in particular in FIGS. 5a and 5b by the reference FL. FIG. 5a shows the time evolution of the voltage signals measured at the output of various electronic stages of an optoelectronic sensor in response to the emission of the time sequence of light beams when an object reflecting the light beams is positioned in the predetermined detection area Zd. FIG. 5b, for its part, shows the time evolution of the same voltage signals in response to the emission of the time sequence of light beams when the object reflecting the light beams is positioned beyond the predetermined detection area Zd.

In these second examples, the optoelectronic sensor 1 may comprise a controlled inverter stage 11 configured to invert the output voltage of the subtractor stage 5 and to do the same with the output voltage of the summing stage 6 during the time intervals between the emission of two consecutive light beams of the time sequence of light beams. The output voltage of the controlled inverter stage 11 acting on the output voltage (vₐ−v_{b}) of the subtractor stage is shown in particular in FIGS. 3, 5a and 5b by the reference V−. As may be seen in FIGS. 5a and 5b, only the parts of the output voltage signals corresponding to the time intervals between the emission of two light beams of the sequence are inverted, the other parts of the voltage signals not being modified. In other words, the controlled inverter stage 11 applies a gain of −1 to the output voltages of the subtractor stage 5 and summing stage 6 during the time intervals between two consecutive light beams of the time sequence of light beams, and does not modify the other parts forming these output voltages, this being tantamount to considering that the controlled inverter stage 11 applies a gain of 1 to these other parts.

The controlled inverter stage 11 may thus comprise a first controlled inverter 11a connected to the output voltage of the subtractor stage 5 and configured to invert the output voltage (vₐ−v_{b}) of the subtractor stage 5 during the time intervals between the emission of two consecutive light beams of the time sequence of light beams. The controlled inverter stage 11 may also comprise a second controlled inverter 11b connected to the output voltage of the summing stage 6 and configured to invert the output voltage (vₐ+v_{b}) of the summing stage 6 during the time intervals between the emission of two consecutive light beams of the time sequence of light beams. The output voltage of the second controlled inverter 11b is thus represented by the reference V+in FIG. 3.

In the second examples, the optoelectronic sensor 1 may comprise an integrator stage 14 connected to the controlled inverter stage 11 and configured to integrate the output voltages V− and V+ of the controlled inverter stage 11. The integrator stage 14 may comprise a first integrator 14a connected to the first controlled inverter 11a and configured to integrate the voltage V−, corresponding to the output voltage of the subtractor stage 5 (vₐ−v_{b}) partially inverted by the controlled inverter stage 11, so as to obtain a first detection signal V_{DIFF}, referred to as “subtractor detection signal”. The integrator stage 14 may also comprise a second integrator 14b connected to the second controlled inverter 11b and configured to integrate the voltage V+, corresponding to the output voltage of the summing stage 6 (vₐ+v_{b}) partially inverted by the controlled inverter stage 11, so as to obtain a second detection signal V_{SUM}, referred to as “summer detection signal”.

The subtractor detection signal is a label used to designate the output voltage of the integrator stage 14, associated with the subtractor stage 5 of the optoelectronic sensor 1, whereas the summer detection signal is another label used to designate the output voltage of the integrator stage 14, associated with the summing stage 6 of the optoelectronic sensor 1.

In these second examples, an object 10 is detected in the predetermined detection area Zd when:
a) the subtractor detection signal V_{DIFF} is positive; and
b) the summer detection signal V_{SUM} is greater than a determined second voltage threshold vₜₕ₂.

In these second examples, the optoelectronic sensor 1 may thus comprise a comparator stage for the integrator stage 12, comprising a first comparator 12a configured to compare the output voltage of the first integrator 14a of the integrator stage 14 with a zero voltage, and comprising a second comparator 12b configured to compare the output voltage of the second integrator 14b of the integrator stage 14 with the predetermined second voltage threshold vₜₕ₂. The optoelectronic sensor 1 may furthermore comprise, in these examples, the logic gate 8 that applies an AND function and receives the outputs of the first comparator 14a and the second comparator 14b at input, configured to transmit a logic signal to the detection unit 9 that triggers detection of an object 10 in the predetermined detection area when the logic signal from the AND gate that it receives is at 1.

These second examples involve considering a time sequence of light beams to detect whether or not an object 10 is present in the predetermined detection area. In this case, the amplitude of the noise on the signal generated by the photodiode and the following amplifier stages in response to a received luminous flux varies over time. Therefore, the amplitude of the noise on the signal generated by the photodiode and the following electronic stages varies for each light beam in a sequence of light beams emitted by the light source 2. To this extent, partially inverting and then integrating the voltages generated at the output of the subtractor stage 5 and/or of the summing stage 6 in response to the reception of multiple light beams emitted by the light source 2 makes it possible to make the voltages at the output of the integrators less dependent on the variable noise than a single light beam might generate, since the variability of the noise is averaged by considering multiple beams. In this respect, the comparison of these output voltages with a threshold is much less dependent on the electronic noise introduced by the various elements of the optoelectronic sensor 1. In particular, and as shown clearly in FIGS. 5a and 5b, it will be understood that a voltage difference between a voltage signal V_{DIFF} in a situation in which the object is positioned in the predetermined detection area Zd (FIG. 5a) and a voltage signal V_{DIFF} in a situation in which the object is positioned beyond this area (FIG. 5b) is greater the more light beams there are in the time sequence of light beams, meaning that confusion of these two situations due to electronic noise is greatly reduced.

Moreover, it is no longer necessary to synchronize the comparisons of the thresholds with the emission of a light beam, as proposed in the first examples. Indeed, the output voltages V_{DIFF} and V_{SUM} of the integrator stage are continuous, meaning that, once the time sequence of light beams has been emitted and before these voltages are relaxed for the emission of the next time sequence, the comparison of these voltages with their respective threshold (zero voltage for V_{DIFF} and vₜₕ₂ for V_{SUM}) may be carried out without the need for accuracy concerning the time when these voltages are compared.

In these second examples, the second voltage threshold vₜₕ₂ is determined based on the number of light beams emitted by the light source 2. In particular, in some examples, the second voltage threshold vₜₕ₂ is a hysteresis threshold having an upper bound and a lower bound. In these examples, the optoelectronic sensor is configured to detect the object in the predetermined detection area Zd when the subtractor detection signal V_{DIFF} is positive and when the summer detection signal V_{SUM} is greater than the upper bound of the second voltage threshold vₜₕ₂. In these examples, the optoelectronic sensor is also configured to interrupt the detection of the object when the summer detection signal V_{SUM} is lower than the lower bound of the hysteresis threshold of the second voltage threshold vₜₕ₂.

In this case, the combination of the controlled inverter stage 11 and the integrator stage 14, allowing the subtractor detection signal V_{DIFF} and the summer detection signal V_{SUM} to be obtained, forms a synchronous demodulation stage for the time sequence of light beams. Indeed, the emission of a time sequence of light beams used to detect the presence of an object in the predetermined detection area Zd may be considered to be one way of modulating the information concerning the presence or absence of the object in the predetermined detection area Zd on the various beams of the time sequence. Therefore, recombining the information coming from each of these beams and translated onto the voltages by carrying out a controlled inversion of these voltages and integrating them may be considered to be synchronous demodulation of the information concerning presence or absence of the object. Moreover, the combined use of the controlled inverter stage 11 and the integrator stage 14 also acts as a filter on a continuous or low-frequency external signal that might disturb the first and second voltages vₐ and v_{b} generated by the reflected light beams of the sequence. Indeed, the controlled inverter stage 11, which applies a positive or negative unity gain to the frequency of the sequence, therefore gives the disturbing signal an alternating character, so that its integration by the integrator stage 14 is zero.

The optoelectronic sensor 1 according to the present disclosure thus makes it possible to guarantee detection stability while at the same time making the difference in detection distance of an object by the sensor 1 negligible when this object is not particularly reflective or highly reflective to the luminous flux.

The various examples presented in the following paragraphs of the present disclosure may be combined independently with the first or second examples described above, unless expressly indicated otherwise.

In some examples, the optoelectronic sensor 1 comprises an emission lens 21, as shown in FIG. 2. The emission lens 21 is arranged opposite the light source 2 such that the light beam emitted by the light source passes through it. It makes it possible to deflect the light rays of the light beam emitted by the light source 2 so as to make them converge at output.

In some examples, the optoelectronic sensor 1 also comprises a reception lens 31, as shown in FIG. 2. The reception lens 31 is arranged opposite the first and second photodiodes 3a and 3b such that the fluxes received by the first and second photodiodes 3a and 3b pass through it. The reception lens 31 makes it possible to concentrate these luminous fluxes toward the photodiodes 3.

In some examples, the sensor 1 comprises a signal amplifier stage capable of amplifying the first and second electric currents iₐ and i_{b} or capable of amplifying the first and second voltages vₐ and v_{b}. The signal amplifier stage may for example be arranged between the photodiodes 3 and the converter stage 4, in which case it will amplify the first and second electric currents iₐ and i_{b}. The signal amplifier stage may also be arranged between the converter 4 and the summing stage 6 and the subtractor stage 5, in which case it will amplify the first and second voltages vₐ and v_{b}. In some examples in which the subtractor stage 5 and/or the summing stage 6 comprise an amplifier, there are therefore at least two signal amplifications, one applied to the currents or voltages, and one applied to amplify the output voltage of the subtractor stage 5 and/or summing stage 6.

In some examples, the converter stage 4 is also an amplifier stage and comprises a first transimpedance amplifier 41a capable of amplifying and converting the first electric current iₐ into a first voltage vₐ and a second transimpedance amplifier 41b capable of amplifying and converting the second electric current i_{b} into a second voltage v_{b}. These examples make it possible, using one and the same electronic element, to amplify and convert a current into a voltage, thereby making it possible to reduce the cost of the sensor and simplify its design. The converter stage 4 having the first transimpedance amplifier 41a and the second transimpedance amplifier 41b may therefore in particular correspond to the abovementioned signal amplifier stage.

In some examples, the optoelectronic sensor 1 may comprise an ambient-light compensation stage 13 configured to compensate for current induced by ambient light in the current generated by the photodiodes 3. In some examples, the ambient-light compensation stage 13 may comprise a first compensation stage 13a connected in antiparallel with the first transimpedance amplifier 41a of the converter stage and a second compensation stage 13b connected in antiparallel with the second transimpedance amplifier 41b of the converter stage 4. More precisely, the first compensation stage 13a may comprise a first low-pass filter 131a connected to a first amplifier 132a, the first amplifier 132a also being connected to a first voltage/current converter 133a, as illustrated in FIG. 3. Similarly, the second compensation stage 13b may comprise a second low-pass filter 131b connected to a second amplifier 132b, the first amplifier 132a also being connected to a second voltage/current converter 133b.

In some examples, the optoelectronic sensor 1 may comprise a filtering stage F configured to filter the first and second voltages vₐ and v_{b}. The filtering is carried out before these voltages are subtracted by the subtractor stage 5 or summed by the summing stage 6. The filtering stage F therefore comprises two filters. The filtering stage comprises a first filter F1 for filtering the first voltage vₐ in order to obtain a filtered voltage v_{aF}, as shown in FIG. 3. The filtering stage F comprises a second filter F2 for filtering the second voltage v_{b}in order to obtain a filtered voltage v_{bF}, as shown in FIG. 3. The first and second filters are bandpass filters. These filters are substantially centered around the frequency of the sequence of light beams in the second examples. The impact of spectral components induced by light sources other than the light source 2 of the optoelectronic sensor 1 on the first and second voltages vₐ and v_{b} is thereby reduced. Since the detection of an object 10 in the predetermined detection area is based on the use of the first and second voltages vₐ and v_{b}, the detection is made more accurate. Moreover, the bandpass filter also makes it possible to substantially filter the noise introduced by the electronic components used in the sensor on the first voltage vₐ and the second voltage v_{b}, in particular the noise introduced by the photodiodes 3, the noise introduced by the converter stage 4 and the noise introduced by the amplifier stage or the ambient-light compensation stage 13, where applicable. Indeed, the noise may be considered to be substantially constant over all of the frequencies of the signal, such that applying a bandpass filter to the voltages makes it possible to suppress the spectral components of the noise outside of the frequency band under consideration, which is weak compared to the set of frequencies making up the signal.

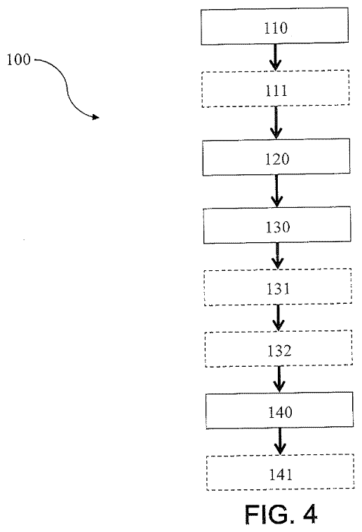

One example of a method 100 for detecting an object 10 in a predetermined detection area through reflection of at least one light beam from the object 10 using an optoelectronic sensor 1 according to the present disclosure will now be presented with reference to FIG. 4.

As illustrated by FIG. 4, the method 100 comprises an operation 110 of emitting at least one light beam in a predetermined time interval using the light source 2.

As illustrated by FIG. 4, the method 100 comprises an operation 120 of obtaining the output voltage of the subtractor stage 5 during the predetermined time interval. The output voltage of the subtractor stage 5 is thus composed of amplitudes generated by the at least one light beam emitted by the light source 2.

As illustrated by FIG. 4, the method 100 comprises an operation 130 of obtaining the output voltage of the summing stage 6 during the predetermined time interval. The output voltage of the summing stage 6 is also composed of amplitudes generated by the at least one light beam.

As illustrated by FIG. 4, the method 100 comprises an operation 140 of detecting an object 10 in the predetermined detection area Zd based on the obtained output voltages of the subtractor stage 5 and the summing stage 6.

In particular, in some first examples of a method 100 in which the optoelectronic sensor 1 using which the method 100 may be carried out corresponds to the optoelectronic sensor 1 according to the first examples described above, an object 10 may be detected in the predetermined detection area when:
a) the output voltage of the subtractor stage is positive when the light beam is emitted, and
b) the output voltage of the summing stage is greater than the predetermined first voltage threshold when the light beam is emitted.

In some second examples of a method 100 in which the optoelectronic sensor 1 using which the method 100 may be carried out corresponds to the optoelectronic sensor 1 according to the second examples described above, the operation 110 of emitting at least one light beam may comprise an operation 111 of emitting a time sequence of light beams in a predetermined time interval using the light source 2.

In these second examples of a method 100, the output voltage of the subtractor stage 5 and the output voltage of the summing stage 6 comprise amplitudes generated by the light beams of the sequence of light beams.

In these second examples of a method 100, the method 100 may furthermore comprise an operation 131 of processing the output voltage of the subtractor stage 5 by inverting the output voltage (vₐ−v_{b}) of the subtractor stage 5 during the time intervals between the emission of two consecutive light beams of the time sequence of light beams and then by integrating the partially rectified voltage (V−) to obtain the subtractor detection signal V_{DIFF}. The subtractor detection signal V_{DIFF} is therefore dependent on the number of light beams in the time sequence. It may be obtained from the first controlled inverter 11a of the controlled inverter stage 11 and from the first integrator 14a of the integrator stage 14.

In these second examples of a method 100, the method 100 may furthermore comprise an operation 132 of processing the output voltage of the summing stage 6 by inverting the output voltage (vₐ+v_{b}) of the summing stage 6 during the time intervals between the emission of two consecutive light beams of the time sequence of light beams and then by integrating the partially rectified voltage (V+) to obtain the summer detection signal V_{SUM}. The summer detection signal V_{SUM} is therefore dependent on the number of light beams in the time sequence. It may be obtained from the second controlled inverter 11b of the controlled inverter stage 11 and from the second integrator 14b of the integrator stage 14.

Finally, in these second examples of a method 100, the operation 140 of detecting an object 10 in the predetermined detection area may furthermore comprise an operation 141 of detecting an object 10 in the predetermined detection area when:
a) the subtractor detection signal V_{DIFF} is positive, and
b) the summer detection signal is greater than the determined second voltage threshold vₜₕ₂.

The examples of an optoelectronic sensor 1 and detection method 100 presented in the present disclosure thus make it possible to guarantee detection stability by ensuring a sufficient signal-to-noise ratio, be this with regard to electronic noise introduced by the various electronic components of the optoelectronic sensor or noise introduced by ambient light in the generation of current by the photodiodes. In this case, the fact that the optoelectronic sensor 1 according to the present disclosure uses the output voltage of a summing stage 6 that adds the voltages resulting from the currents generated by the first and second photodiodes 3a and 3b in the detection of an object 10 in the predetermined detection area makes it possible to guarantee detection stability (object detected or not detected) by ensuring a sufficient signal-to-noise ratio that makes it possible to avoid switching from one state to another due to noise. Moreover, in the second examples of an optoelectronic sensor 1 based on the emission of a time sequence of light beams to detect an object 10 in the predetermined area Z_{d}, the influence of noise on detection stability is reduced further. Specifically, noise on the voltages is filtered by the combination of the controlled inverter stage 11 and the integrator stage 14, and the output voltages that are compared to detect or not detect an object, that is to say the detection signals V_{DIFF} and V_{SUM}, have an increased level compared to the first examples, thereby further increasing the signal-to-noise ratio, thus improving detection stability.

1.-8. (canceled)

9. An optoelectronic sensor configured to detect a presence of an object in a predetermined detection area through reflection of at least one light beam from said object (10), the optoelectronic sensor (1) comprising:
a light source adapted to emit the at least one light beam with a predetermined orientation;
a first photodiode configured to generate a first electric current as a function of a first luminous flux on the first photodiode;
a second photodiode configured to generate a second electric current as a function of a second luminous flux on the second photodiode;
a position of the first (3a) and second (3b) photodiodes is determined such that a difference between the first luminous flux received by the first photodiode and the second luminous flux received by the second photodiode is positive when the light beam is reflected by the object positioned in the predetermined detection area;
a converter stage configured to convert the first and second electric currents and into first and second voltages;
a subtractor stage configured to generate an output voltage by subtracting the second voltage from the first voltage (vₐ);
a summing stage configured to generate an output voltage by adding the first voltage to the second voltage;
wherein the optoelectronic sensor furthermore comprises a controlled inverter stage and an integrator stage, the controlled inverter stage comprising:
a first controlled inverter connected to the subtractor stage and configured to invert the output voltage of the subtractor stage during time intervals between the emission of two consecutive light beams of the time sequence of light beams;
a second controlled inverter connected to the summing stage and configured to invert the output voltage of the summing stage during the time intervals between the emission of two consecutive light beams of the time sequence of light beams;
the integrator stage comprising:
a first integrator connected to the first controlled inverter and configured to integrate the output voltage of the subtractor stage, partially inverted by the first controlled inverter stage, so as to obtain a detection signal of the subtractor; and
a second integrator connected to the second controlled inverter and configured to integrate the output voltage of the summing stage, partially inverted by the second controlled inverter stage, so as to obtain a detection signal of the summer; and
wherein the optoelectronic sensor is configured to detect an object in the predetermined detection area when:
a) the detection signal of the subtractor is positive, and
b) the detection signal of the summer is greater than a determined second voltage threshold.

10. The optoelectronic sensor of claim 9, comprising a signal amplifier stage capable of amplifying the first and second electric currents or capable of amplifying the first and second voltages.

11. The optoelectronic sensor of claim 9, wherein the converter stage is also an amplifier stage and comprises a first transimpedance amplifier capable of amplifying and converting the first electric current into a first voltage and a second transimpedance amplifier capable of amplifying and converting the second electric current into a second voltage.

12. The optoelectronic sensor of claim 9, furthermore comprising an ambient-light compensation stage configured to reduce a portion of current induced by ambient light in a current generated by the photodiodes.

13. The optoelectronic sensor of claim 9, wherein the subtractor stage and the summing stage also comprise an amplifier that amplifies their respective output voltage.

14. The optoelectronic sensor of claim 9, furthermore comprising a filtering stage configured to filter the first and second voltages.

15. The optoelectronic sensor of claim 9, furthermore comprising:
an emission lens arranged facing the light source so that the light beam emitted by the light source passes through the emission lens; and
a reception lens arranged facing the first and second photodiodes so that the fluxes received by the first and second photodiodes pass through the reception lens.

16. A method for detecting an object in a predetermined detection area through reflection of at least one light beam from the object using the optoelectronic sensor of claim 9, the method comprising:
emitting a time sequence of light beams in a predetermined time interval using the light source;
obtaining the output voltage of the subtractor stage during the predetermined time interval, the output voltage of the subtractor stage being composed of amplitudes generated by the light beams of the sequence of light beams;
processing the output voltage of the subtractor stage by inverting the output voltage of the subtractor stage during the time intervals between the emission of two consecutive light beams of the time sequence of light beams and then integrating the partially rectified voltage so as to obtain a detection signal of the subtractor, from the first controlled inverter and the first integrator;
obtaining the output voltage of the summing stage during the predetermined time interval, the output voltage of the summing stage being composed of amplitudes generated by the light beams of the sequence of light beams;
processing the output voltage of the summing stage by inverting the output voltage of the summing stage during the time intervals between the emission of two consecutive light beams of the time sequence of light beams and then integrating the partially rectified voltage so as to obtain a detection signal of the summer, from the second controlled inverter and the second integrator; and
detecting the object in the predetermined detection area when:
a) the detection signal of the subtractor is positive; and
b) the detection signal of the summer is greater than a determined second voltage threshold.
